(19) United States
(12) Patent Application Publication
(10) Pub. No.: US 2026/0134847 A1
(43) Pub. Date: May 14, 2026

(54) LIQUID CRYSTAL DISPLAY DEVICE

(71) Applicant: Sharp Display Technology Corporation, Kameyama City (JP)

(72) Inventor: Haruhito YABUKI, Kameyama City (JP)

(21) Appl. No.: 19/381,017

(22) Filed: Nov. 6, 2025

(30) Foreign Application Priority Data
Nov. 11, 2024 (JP) 2024-196811

(51) Int. Cl. G09G 3/36

(52) U.S. Cl. CPC G09G 3/3607; G09G 3/3648; G09G 2320/0233

(57) ABSTRACT

A liquid crystal display device is configured such that a control circuit adjusts a gray scale value for generating a source signal to be supplied via a spare wiring line to a source bus line electrically connected to the spare wiring line to a value not lower than a first gray scale value that is larger than a lowest gray scale value, and/or adjusts the above gray scale value to a value not higher than a second gray scale value that is smaller than a highest gray scale value.

### CROSS-REFERENCE TO RELATED APPLICATIONS

This application claims the benefit of priority to Japanese Patent Application Number 2024-196811 filed on Nov. 11, 2024. The entire contents of the above-identified application are hereby incorporated by reference.

### BACKGROUND

### Technical Field

The disclosure relates to a liquid crystal display device, and particularly relates to a high-resolution liquid crystal display device.

In an active matrix liquid crystal display device including a thin film transistor (TFT) on a pixel-by-pixel basis, there is known a method of repairing a disconnection failure of a source bus line, when a disconnection has occurred in the source bus line, by connecting a spare wiring line (also referred to as a redundant wiring line) to a portion where an electrical connection with a source drive circuit is cut due to the disconnection in the source bus line (typically, a portion farther from the source drive circuit than the disconnection portion) and then supplying a source signal to the above portion via the spare wiring line. The source signal is supplied directly to the source bus line (through a normal path) from the source drive circuit to a portion closer to the source drive circuit than the disconnection portion in the source bus line (sometimes referred to as “direct side”), the source signal is supplied via the spare wiring line to a portion farther from the source drive circuit than the disconnection portion in the source bus line (sometimes referred to as a “bypass side”), and thus the source voltage is applied to all the pixels connected to the source bus line in which the disconnection has occurred. The spare wiring line is electrically connected to the vicinity of an end portion of the source bus line on a side farther from the source drive circuit than the disconnection portion of the source bus line so that the source signal can be supplied to the bypass side of the source bus line.

For example, according to WO 2020/012654, a first gray-scale voltage, corrected to be lower than a gray-scale voltage to be output to a source bus line based on a position of a disconnection portion in the source bus line and a wiring line resistance of the source bus line, is output to a direct side of the source bus line, and a second gray-scale voltage, corrected based on the position of the disconnection portion, the wiring line resistance of the source bus line and a wiring line resistance of a spare wiring line, is output to a bypass side of the source bus line, whereby a deviation in luminance of pixels along the source bus line having the disconnection portion can be reduced with a simple configuration.

### SUMMARY

According to embodiments of the disclosure, solutions described in the following items are provided.

### Item 1

A liquid crystal display device includes:
a plurality of pixels arranged in a matrix shape having a plurality of pixel rows and a plurality of pixel columns;
a thin film transistor provided in each of the plurality of pixels;
a plurality of gate bus lines each associated with any of the plurality of pixel rows;
a plurality of source bus lines each associated with any of the plurality of pixel columns;
a spare wiring line arranged to be electrically connectable to any of the plurality of source bus lines;
a gate drive circuit configured to supply a gate signal to the plurality of gate bus lines;
a source drive circuit configured to supply a source signal to the plurality of source bus lines; and
a control circuit configured to supply a control signal to the gate drive circuit and the source drive circuit, wherein
the control circuit is configured to adjust a gray scale value for generating a source signal to be supplied via the spare wiring line to a source bus line electrically connected to the spare wiring line to a value not lower than a first gray scale value that is higher than a lowest gray scale value and/or to a value not higher than a second gray scale value that is lower than a highest gray scale value.

### Item 2

The liquid crystal display device according to item 1, wherein
the control circuit is configured to adjust a gray scale value for generating a source signal to be directly supplied, not via the spare wiring line, to a source bus line electrically connected to the spare wiring line to a value not lower than the first gray scale value and/or to a value not higher than the second gray scale value.

### Item 3

The liquid crystal display device according to item 1 or 2, wherein
the first gray scale value and/or the second gray scale value may be changed in accordance with a position of a pixel that receives a source signal to be supplied to a source bus line electrically connected to the spare wiring line.

### Item 4

The liquid crystal display device according to item 3, wherein
as a pixel that receives a source signal to be supplied to a source bus line electrically connected to the spare wiring line is closer to a disconnection portion, the first gray scale value is made larger and/or the second gray scale value is made smaller at a time of adjusting a gray scale value for generating the source signal.

### Item 5

The liquid crystal display device according to item 1 or 2, wherein
the control circuit is configured to adjust a gray scale value for generating a source signal to be supplied to a source bus line electrically connected to the spare wiring line either to a value not lower than the first gray scale value or to a value not higher than the second gray scale value.

### Item 6

The liquid crystal display device according to item 1 or 2, wherein
the control circuit is configured to adjust a gray scale value for generating a source signal to be supplied to a source bus line electrically connected to the spare wiring line both to a value not lower than the first gray scale value and to a value not higher than the second gray scale value.

### Item 7

The liquid crystal display device according to item 1 or 2, wherein
the control circuit includes a correction circuit, and
the correction circuit is configured to correct a gray scale value for generating a source signal to be supplied to a source bus line electrically connected to the spare wiring line to the first gray scale value in a case where an original value of the gray scale is lower than the first gray scale value and/or to the second gray scale value in a case where the original value of the gray scale is higher than the second gray scale value.

### Item 8

The liquid crystal display device according to item 1 or 2, wherein
the control circuit includes a correction circuit, and
the correction circuit is configured to convert a gray scale value for generating a source signal to be supplied to a source bus line electrically connected to the spare wiring line, in a case where an original value of the gray scale is equal to or smaller than a third gray scale value that is larger than the first gray scale value, to a first conversion gray scale value between the first gray scale value and the third gray scale value and/or convert the gray scale value, in a case where the original value of the gray scale is equal to or larger than a fourth gray scale value that is smaller than the second gray scale value, to a second conversion gray scale value between the second gray scale value and the fourth gray scale value.

### Item 9

The liquid crystal display device according to item 8, wherein
the first conversion gray scale value may be changed in accordance with a difference between the original value of the gray scale and the lowest gray scale value, and the second conversion gray scale value may be changed in accordance with a difference between the original value of the gray scale and the highest gray scale value.

### Item 10

The liquid crystal display device according to item 9, wherein
the first conversion gray scale value is set to be closer to the first gray scale value as the difference between the original value of the gray scale and the lowest gray scale value is smaller, and closer to the third gray scale value as the difference between the original value of the gray scale and the lowest gray scale value is larger, and
the second conversion gray scale value is set to be closer to the second gray scale value as the difference between the original value of the gray scale and the highest gray scale value is smaller, and closer to the fourth gray scale value as the difference between the original value of the gray scale and the highest gray scale value is larger.

According to an embodiment of the disclosure, there is provided a liquid crystal display device in which deterioration in display quality is suppressed when a disconnection failure of a source bus line is repaired using a spare wiring line in a case of the liquid crystal display device being of a relatively high-resolution type.

### BRIEF DESCRIPTION OF DRAWINGS

The disclosure will be described with reference to the accompanying drawings, wherein like numbers reference like elements.

FIG. 1 is a schematic view of a liquid crystal display device 100 according to an embodiment of the disclosure.

FIG. 2 is an internal block diagram of a timing controller 152.

FIG. 3 is a diagram depicting a change in a waveform of a source signal due to a disconnection repair of a source bus line in a known liquid crystal display device.

FIG. 4 is a diagram depicting a change in a waveform of a source signal due to a disconnection repair of a source bus line in a liquid crystal display device according to the embodiment of the disclosure.

FIG. 5 is a diagram depicting a voltage-transmittance curve of a liquid crystal display device.

FIG. 6 is a diagram depicting a gray scale-voltage curve of a liquid crystal display device.

FIG. 7 is a diagram depicting a specific example of clipping processing in Example 1.

FIG. 8 is a diagram depicting a specific example of clipping processing in Example 1.

FIG. 9 is a diagram depicting a specific example of clipping processing in Example 1.

FIG. 10 is a flowchart of a process performed by a correction circuit 152c in Example 1.

FIG. 11 is a diagram depicting a specific example of clipping processing in Example 2.

FIG. 12 is a diagram depicting a specific example of clipping processing in Example 2.

FIG. 13 is a diagram depicting a specific example of clipping processing in Example 2.

FIG. 14 is a flowchart of a process performed by the correction circuit 152c in Example 2.

FIG. 15 is a diagram depicting a specific example of clipping processing in Example 3.

FIG. 16 is a diagram depicting a specific example of clipping processing in Example 3.

FIG. 17 is a diagram depicting a specific example of clipping processing in Example 3.

FIG. 18 is a flowchart of a process performed by the correction circuit 152c in Example 3.

FIG. 19 is a diagram depicting a specific example of clipping processing in Example 4.

FIG. 20 is a diagram depicting a specific example of clipping processing in Example 4.

FIG. 21 is a diagram depicting a specific example of clipping processing in Example 4.

FIG. 22 is a flowchart of a process performed by the correction circuit 152c in Example 4.

FIG. 23 is a diagram for explaining a problem in a known liquid crystal display device.

### DESCRIPTION OF EMBODIMENTS

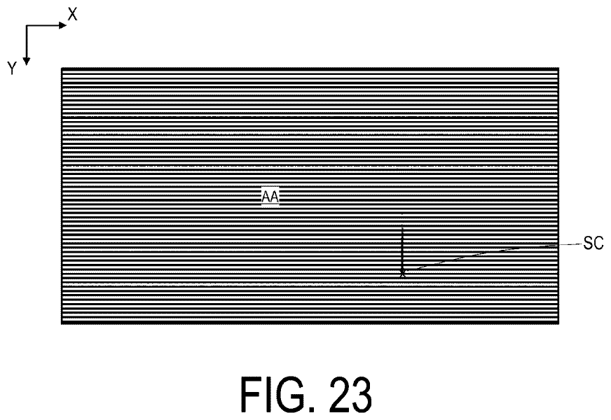

In a relatively high-resolution liquid crystal display device, when a disconnection failure of a source bus line is repaired using a spare wiring line, the display quality may be deteriorated. For example, when horizontal stripe patterns of 0 gray scale and intermediate gray scale are displayed on the entirety of an active area (display region) AA, part of a bypass side (upper side in FIG. 23) of a disconnection portion SC in a source bus line may be visually recognized as a dark line, as schematically illustrated in FIG. 23. This problem is observed, for example, in a case of a 32-inch 8K panel (single source; each source signal waveform is frame-inverted) driven at 120 Hz.

The disclosure has been made to solve the above-described problems, and an object of the disclosure is to provide a liquid crystal display device in which deterioration in display quality is suppressed when a disconnection failure of a source bus line is repaired using a spare wiring line in a case of the liquid crystal display device being of a relatively high-resolution type.

Hereinafter, a liquid crystal display device according to an embodiment of the disclosure will be described with reference to the accompanying drawings. The liquid crystal display device according to the embodiment of the disclosure is not limited to those exemplified below.

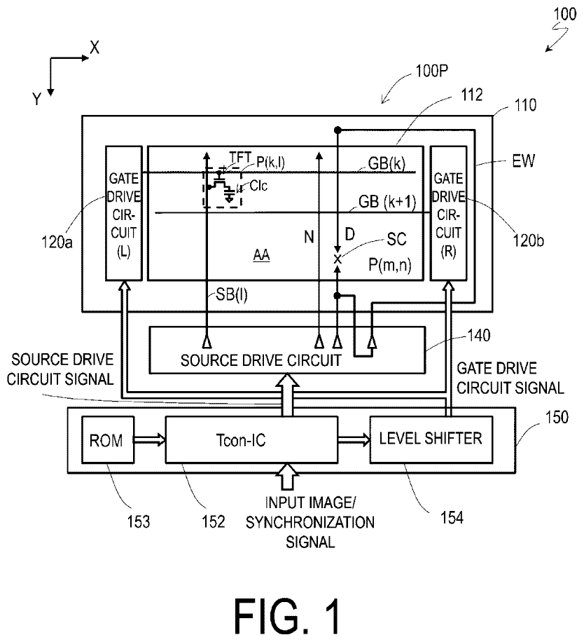

FIG. 1 illustrates a schematic view of a liquid crystal display device 100 according to the embodiment of the disclosure.

The liquid crystal display device 100 includes a plurality of pixels P arrayed in a matrix shape having a plurality of pixel rows (m rows) and a plurality of pixel columns (n columns). The liquid crystal display device 100 is an active matrix liquid crystal display device, and includes a thin film transistor (TFT) and a liquid crystal capacitance Clc for each pixel P. The pixel P may further include an auxiliary capacity Cs (not illustrated) electrically connected in parallel with the liquid crystal capacitance Clc. Herein, for the sake of simplicity, the description of the auxiliary capacity Cs is omitted. The liquid crystal capacitance Clc is constituted by, for example, a pixel electrode (not illustrated) formed on an active matrix substrate 110 and a common electrode (also referred to as a counter electrode; not illustrated) disposed to face the pixel electrode via a liquid crystal layer (not illustrated). The common electrode is formed on a counter substrate 112 disposed to face the active matrix substrate 110, for example. The active matrix substrate 110, the counter substrate 112, the liquid crystal layer interposed therebetween, and constituent elements including gate drive circuits 120a and 120b mounted on the active matrix substrate 110 may be collectively referred to as a liquid crystal display panel or an open cell 100P.

An area in which the plurality of pixels P are formed is referred to as an active area AA or a display region. The pixel in the k-th row and the l-th column among the pixels arrayed in the m rows and the n columns may be referred to as P(k, l). k, l, m, and n are positive integers that satisfy the relationships of 1≤k≤m and 1≤l≤n. For example, in a liquid crystal display device with a so-called resolution of 8K, m is equal to 4320 and n is equal to 7680×3 (when a color display pixel is constituted by an R pixel, a G pixel, and a B pixel, the “pixel” described herein may be referred to as a “dot”, and the “color display pixel” constituted by the three “dots” may be referred to as a “pixel unit”). Each of a plurality of the pixels includes a liquid crystal capacitance Clc including a pixel electrode, and a TFT whose drain electrode is connected to the pixel electrode.

The liquid crystal display device 100 further includes a plurality of gate bus lines GB (m lines), each of which is associated with any of the plurality of pixel rows, and a plurality of source bus lines SB (n lines), each of which is associated with any of the plurality of pixel columns. A gate electrode of the TFT of each pixel is connected to a gate bus line GB associated with a pixel row including the pixel, and a source electrode of the TFT is connected to a source bus line SB associated with a pixel column including the pixel.

The liquid crystal display device 100 further includes the gate drive circuits 120a and 120b configured to supply a plurality of the gate bus lines GB with gate scanning signals including gate-on pulses for setting the TFTs to ON states, and a source drive circuit 140 configured to supply a plurality of the source bus lines SB with source signals. Here, an example is given in which two gate drive circuits 120a (L) and 120b (R) are disposed on the left and right sides, respectively, of the active area AA, but it is needless to say that the gate scanning signal may be supplied to all the gate bus lines from one gate drive circuit disposed on either the left or right side.

The liquid crystal display device 100 is a GOA type, and the gate drive circuits 120a and 120b are formed on the active matrix substrate 110, similarly to the pixel electrodes, the TFTs, the plurality of source bus lines SB, and the plurality of gate bus lines GB. As is well known, the active matrix substrate 110 includes, for example, a conductive layer (metal layer), a semiconductor layer, and an insulating layer on a glass substrate, and is manufactured by a known method. The source drive circuit 140 may be mounted on the active matrix substrate 110 as a source driver IC, or a flexible substrate on which a source driver IC is mounted may be connected to the active matrix substrate 110.

The gate drive circuits 120a and 120b and the source drive circuit 140 are controlled by a control circuit 150. The control circuit 150 includes a timing controller (Tcon-IC) 152, a ROM 153, and a level shifter 154. The timing controller 152 determines a vertical scan period (V; also referred to as a frame) and a horizontal scan period (H) in accordance with the resolution, the drive frequency, and the like of the liquid crystal display device, based on an (input) synchronization signal that is input together with an input image signal or is included in the input image signal. The control circuit 150 supplies necessary control signals such as a gate drive signal and a source drive signal to each of the gate drive circuits 120a and 120b and the source drive circuit 140. The timing controller (Tcon-IC) 152 supplies a gray scale value indicating a gray scale to be displayed to the source drive circuit 140. The liquid crystal display device 100 further includes a power source circuit (not illustrated) that supplies a power supply voltage necessary for each of the gate drive circuits 120a and 120b and the source drive circuit 140.

The source drive circuit 140 generates a source signal based on the gray scale value received from the control circuit 150. The source signal supplied to a certain source bus line includes a source voltage sequentially supplied to a plurality of pixels (m pixels) connected to the certain source bus line via the TFTs, and a corresponding source voltage is applied to a pixel connected to the TFT selected by a gate-on pulse supplied to the gate bus line.

The liquid crystal display device 100 includes a spare wiring line EW. A plurality of the spare wiring lines EW (e.g., six lines each on the left and right sides of the display region, that is, 12 lines in total) are provided on the active matrix substrate 110, and are used for each source bus line SB having a disconnection portion. By fusing the spare wiring line EW selected for the source bus line SB, in which a disconnection has occurred, by irradiation with laser light or the like, the source signal can be supplied from a bypass side of the source bus line SB. As a configuration of the spare wiring line EW and a method of fusing the spare wiring line EW on the source bus line SB, known configurations and methods may be adopted.

In the active area AA, a row direction (parallel to the gate bus lines) is referred to as an X direction, and a column direction (parallel to the source bus lines) is referred to as a Y direction. For example, as illustrated in FIG. 1, X-Y coordinates are defined such that the X coordinate increases in the right direction and the Y coordinate increases in the downward direction with the upper left corner of the active area AA taken as the origin. Any position in the active area AA is represented by (X, Y) coordinates having components of distances from the origin in the X direction and the Y direction, and a pixel is represented by (X, Y) coordinates having components of a column number (l) and a row number (k), that is, (l, k).

The repair of a disconnection portion of the source bus line SB is performed, for example, before a substrate on which the control circuit 150 is mounted is connected to the liquid crystal display panel 100P. When the disconnection portion of the source bus line SB is specified, the (X, Y) coordinates of a pixel closest to the disconnection portion to which the source signal voltage is not supplied due to the disconnection are specified. The coordinates of this pixel as the information of the disconnection portion and the information for specifying the liquid crystal display panel are associated with each other and stored in the ROM 153. The information of the disconnection portion may be only the X coordinate (column number).

The information of the disconnection portion may be acquired as follows, for example. Before the substrate mounted with the control circuit 150 is connected to the liquid crystal display panel 100P, display inspection of the liquid crystal display panel 100P may be performed to visually specify the disconnection portion. For example, an operator moves a displayed cross-shaped pattern to make it overlap the disconnection portion, thereby making it possible to acquire the coordinates of the disconnection portion. Note that other information such as a gamma correction parameter may be stored in the ROM 153.

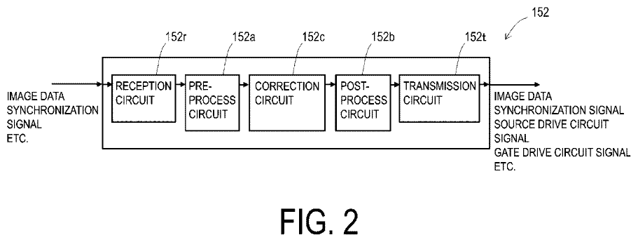

FIG. 2 illustrates an internal block diagram of the timing controller 152. The timing controller 152 includes a reception circuit 152r, a pre-process circuit 152a, a correction circuit 152c, a post-process circuit 152b, and a transmission circuit 152t. The correction circuit 152c performs a correction process such as gamma clipping, as described below. The pre-process circuit 152a and the post-process circuit 152b are provided as needed. The pre-process circuit 152a performs, for example, a digital gamma process and an overshoot process. The post-process circuit 152b performs, for example, dithering. The pre-process circuit 152a and the post-process circuit 152b may be constituted of known circuits.

The liquid crystal display device according to the embodiment of the disclosure is configured such that the control circuit 150 (1) adjusts a gray scale value (a gray scale value of a pixel connected to the bypass side) for generating a source signal to be supplied via the spare wiring line EW to the source bus line SB electrically connected to the spare wiring line EW (the source bus line SB whose disconnection failure has been repaired using the spare wiring line EW) to a value not lower than the first gray scale value that is larger than the lowest gray scale value, and/or (2) adjusts the above gray scale value to a value not higher than the second gray scale value that is smaller than the highest gray scale value. That is, the control circuit may perform only one of (1) and (2), or may perform both (1) and (2). In this case, the lowest gray scale value and the highest gray scale value are respectively the lowest value and the highest value in a gray scale range that can be displayed by the liquid crystal display device; for example, in a case where 1024 gray scales from 0 gray scale to 1023 gray scale can be displayed, the lowest gray scale value and the highest gray scale value are 0 gray scale and 1023 gray scale, respectively. Since the source signal voltage is applied so that the polarity is inverted for each frame with the potential of the common electrode (common voltage) taken as a reference, the source signal voltage is generated so that the absolute value taking the common voltage (sometimes denoted as “COM”) as a reference corresponds to the gray scale value (however, the positive and negative values may be asymmetric in consideration of the influence of the characteristics of the TFT). The first gray scale value in (1) is smaller than the second gray scale value in (2). For example, the first gray scale value is less than the intermediate gray scale value (512 gray scale in 1024-gray scale display), and the second gray scale value is beyond the intermediate gray scale value (512 gray scale in 1024-gray scale display).

In the present specification, (1) adjusting the gray scale value to a value not lower than the first gray scale value that is larger than the lowest gray scale value may be referred to as clipping to the first gray scale value, and (2) adjusting the gray scale value to a value not higher than the second gray scale value that is smaller than the highest gray scale value may be referred to as clipping to the second gray scale value. Clipping to the first gray scale value in (1) includes not only fixing to a constant first gray scale value but also converting to any gray scale value that is not lower than a predetermined first gray scale value, for example. Clipping to the second gray scale value in (2) includes not only fixing to a constant second gray scale value but also converting to any gray scale value that is not higher than a predetermined second gray scale value, for example.

Clipping processing may be performed by the correction circuit 152c included in the control circuit 150, for example, as follows. For example, the correction circuit 152c may be configured to correct a gray scale value for generating a source signal to be supplied to the source bus line SB electrically connected to the spare wiring line EW to (1) the first gray scale value in a case where an original value of the gray scale is lower than the first gray scale value, and/or to (2) the second gray scale value in a case where the original value of the gray scale is higher than the second gray scale value. Here, the original value of the gray scale refers to a gray scale value for generating a source signal to be supplied when there is no disconnection in the source bus line.

Further, for example, the correction circuit 152c may be configured to convert a gray scale value for generating a source signal to be supplied to the source bus line SB electrically connected to the spare wiring line EW to (1) a first conversion gray scale value between the first gray scale value and a third gray scale value in a case where the original value of the gray scale is equal to or smaller than the third gray scale value that is larger than the first gray scale value, and/or to (2) a second conversion gray scale value between the second gray scale value and a fourth gray scale value in a case where the original value of the gray scale is equal to or larger than the fourth gray scale value that is smaller than the second gray scale value.

In this case, the first conversion gray scale value may be changed in accordance with a difference between the original value of the gray scale and the lowest gray scale value, and the second conversion gray scale value may be changed in accordance with a difference between the original value of the gray scale and the highest gray scale value, for example.

Further, for example, the first conversion gray scale value is set to be closer to the first gray scale value as the difference between the original value of the gray scale and the lowest gray scale value is smaller, and closer to the third gray scale value as the difference between the original value of the gray scale and the lowest gray scale value is larger; the second conversion gray scale value is set to be closer to the second gray scale value as the difference between the original value of the gray scale and the highest gray scale value is smaller, and closer to the fourth gray scale value as the difference between the original value of the gray scale and the highest gray scale value is larger.

The source signal supplied via the spare wiring line EW is significantly affected by a load (CR) because the wiring line from the source drive circuit to the pixel is long; the gray scale value for generating the source signal directly supplied to the source bus line SB electrically connected to the spare wiring line EW without passing through the spare wiring line EW (the gray scale value of the pixel connected to the direct side) may be adjusted to (1) a gray scale value not lower than the first gray scale value that is larger than the lowest gray scale value and/or to (2) a gray scale value not higher than the second gray scale value that is smaller than the highest gray scale value, similarly to the gray scale value for generating the source signal supplied via the spare wiring line EW. In this case, a clipping amount (direct side) for adjusting the gray scale value for generating the source signal directly supplied to the source bus line SB electrically connected to the spare wiring line EW without passing through the spare wiring line EW may be set independently of a clipping amount (bypass side) for adjusting the gray scale value for generating the source signal supplied via the spare wiring line EW.

The first gray scale value and the second gray scale value in (1) and (2) may be changed in accordance with a position of the pixel that receives the source signal to be supplied to the source bus line SB electrically connected to the spare wiring line EW. For example, as the pixel is closer to the disconnection portion, (1) the first gray scale value may be set to be larger and/or (2) the second gray scale value may be set to be smaller.

Hereinafter, the liquid crystal display device according to the embodiment of the disclosure will be described exemplifying a 32-inch liquid crystal display device of 8K resolution (m=4320, Y=1 to 4320). The display gray scale takes 1024 gray scales (0 to 1023).

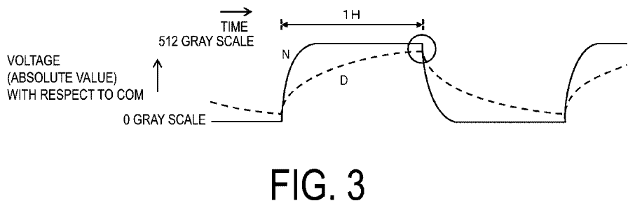

First, a problem of a known liquid crystal display device will be described with reference to FIGS. 3 and 23.

As schematically illustrated in FIG. 23, when horizontal stripe patterns of 0 gray scale and 512 gray scale are displayed on the known liquid crystal display device, part of a bypass side (upper side in FIG. 23) of a disconnection portion SC in a source bus line is visually recognized as a dark line. In this case, as illustrated in FIG. 3, compared to a waveform N of a source signal on a normal source bus line (corresponding to “N” in FIG. 1), a waveform D of a source signal on the bypass side (corresponding to “D” in FIG. 1) of the disconnection portion SC in the source bus line is rounded and does not reach a predetermined voltage. In the case of the horizontal stripe patterns, the waveform of the source signal changes in one frame, and thus the waveform is rounded depending on the load (CR). In particular, since the source signal is supplied via a spare wiring line to the source bus line whose disconnection portion has been corrected, the load is larger than that of the normal source bus line, the waveform is largely rounded, and the voltage cannot reach a target voltage, thereby forming the dark line. When intermediate gray scale display is performed on the entire screen, since the waveform of the source signal is constant (DC) in one frame, the waveform is not affected by the load, and thus no problem occurs even when the disconnection portion is corrected.

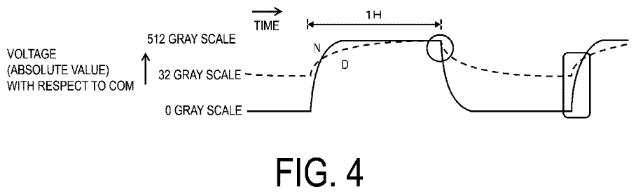

In the liquid crystal display device 100 according to the embodiment of the disclosure, the correction circuit 152c included in the timing controller 152 fixes the gray scale values from 0 gray scale (lowest gray scale value) to 32 gray scale, for example, to 32 gray scale. That is, as illustrated in FIG. 4, a waveform of a source signal in the liquid crystal display device 100 according to the embodiment is such that, as a result of the 0 gray scale value being fixed to 32 gray scale, the waveform D of the source signal on the bypass side (“D” in FIG. 1) of the disconnection portion SC in the source bus line also reaches the target voltage, similarly to the waveform N of the source signal on the normal source bus line (“N” in FIG. 1), and thus, no dark line appears.

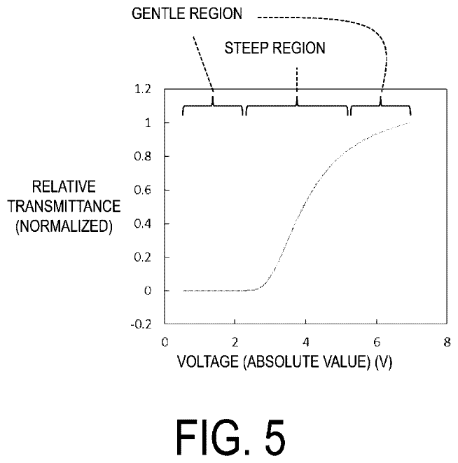

The liquid crystal display device exhibits a voltage-transmittance (V-T) curve as depicted in FIG. 5. In FIG. 5, the horizontal axis represents a voltage applied to the liquid crystal layer, and indicates the absolute value of a source signal voltage with respect to the common voltage (COM); the relative transmittance is normalized to 1 on the vertical axis. Since the dark (low gray scale) side of the horizontal stripe pattern is a region where the voltage-transmittance curve of the liquid crystal display device is gentle (a change in transmittance with respect to a change in voltage is slow), even in a case where an error in voltage occurs to some degree, the influence on the transmittance (luminance) is small, and the influence on the display can be ignored. On the other hand, since the intermediate voltage (intermediate gray scale) is in a region where the change in transmittance with respect to the change in voltage is steep, even in a case where the waveform of the source signal is rounded and an error in voltage occurs in the above-described horizontal stripe pattern, a transmittance (luminance) error is small at the 0 gray scale and the transmittance (luminance) error is large at the intermediate gray scale. Therefore, even at the expense of the 0 gray scale, the display quality can be substantially improved by reducing the error of the intermediate gray scale. Further, since the voltage-transmittance curve of the liquid crystal display device near the high gray scale (1023 gray scale) is also in a gentle region (the change in transmittance with respect to the change in voltage is slow), the deterioration in display quality that occurs when the horizontal stripe pattern of, for example, 1023 gray scale and 512 gray scale is displayed can be reduced by reducing the error of the intermediate gray scale even at the expense of the 1023 gray scale.

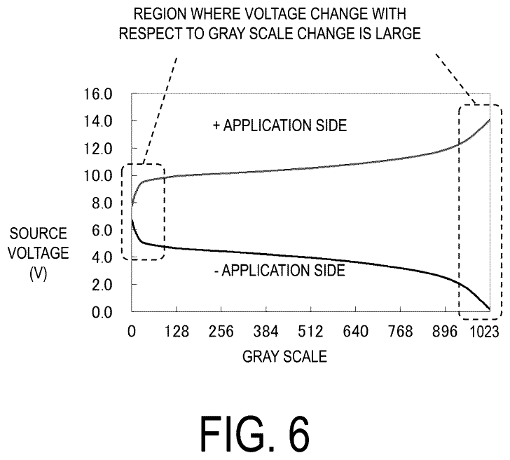

In the gray scale-voltage curve depicted in FIG. 6, the voltage is largely shifted by slightly shifting the gray scale in the vicinity of 0 gray scale. That is, only by slightly gamma-clipping the vicinity of the 0 gray scale (that is, only by fixing to a slightly higher gray scale), the voltage is largely shifted, so that the amount of voltage change with respect to the intermediate gray scale of the subsequent bright pixel can be reduced. Since the amount of voltage change is small, the source signal voltage can reach the target voltage even when the load on the source signal is large. In other words, the attained voltage is unlikely to depend on the load on the source signal. Even in a case where the target voltage is not completely reached, a voltage close to the target voltage can be reached. In this way, the occurrence of the dark line discussed above can be suppressed in the liquid crystal display device according to the embodiment of the disclosure. In the gray scale-voltage curve, the voltage is largely shifted only by slightly shifting the gray scale also in the vicinity of 1023 gray scale. Accordingly, similarly to the case of the vicinity of the 0 gray scale, only by slightly gamma-clipping the vicinity of the 1023 gray scale (that is, only by fixing to a slightly lower gray scale), the voltage is largely shifted, so that the amount of voltage change with respect to the intermediate gray scale of the subsequent dark pixel can be reduced.

In the case of a relatively high-resolution liquid crystal display device including small pixels for 32-inch 8K resolution, even when only a disconnection correction portion of a source bus line (width of one pixel column (one pixel column of only one of R, G, and B)) is subjected to slight gamma clipping in a quantity of about 32 gray scales (32/1024 gray scales), a difference due to the clipping cannot be visually recognized, and thus no problem arises in actual use.

A manner and conditions of clipping processing of the source signal can be set in various ways. For example, it is possible to appropriately set whether the clipping processing is performed in units of pixel columns or performed somewhere (clipping location) in a pixel column, whether the clipping processing is performed commonly or independently on the bypass side and the direct side (common clipping or independent clipping), and whether the clipping processing is performed on a bright (high gray scale) side or a dark (low gray scale) side (either (1) or (2) described above) or performed on both the sides. Specific examples of the clipping processing will be described below while giving Example 1 to Example 4. The relationship between the display region AA and the coordinates in Examples is as illustrated in FIG. 1.

### Example 1

In Example 1, all pixels connected to a source bus line (a source bus line electrically connected to a spare wiring line) in which a disconnection has occurred are clipped under specified conditions regardless of the position (Y coordinate) of each pixel. In this case, setting values related to the clipping processing can be made common among different liquid crystal display devices except for the X coordinate (l) specifying the source bus line in which the disconnection has occurred.

Clipping location: all the pixels connected to the source bus line in which the disconnection has occurred are to be clipped
Common/Independent clipping: common to the bypass side/direct side of the disconnection portion of the source bus line
Clipping gray scale: constant for all the pixels without depending on the Y coordinate
Bright side/Dark side clipping: only the dark side (only (1) described above)

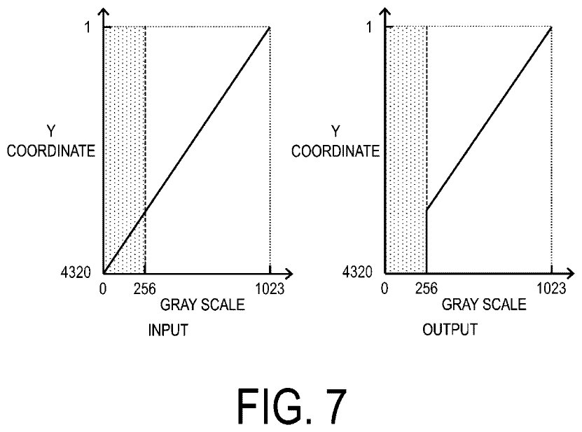

FIGS. 7 to 9 each describe a specific example of the clipping processing under the above-described conditions. An input depicted at the left side of each drawing indicates an example of an input (original gray scale) to the correction circuit 152c of FIG. 2, and an output depicted at the right side indicates an output from the correction circuit 152c of FIG. 2 when there is an input on the left side.

When the original value of the gray scale (input) is less than the clipping gray scale (the first gray scale value described above, which is 256 gray scale in this case) on the dark side, all the pixels (Y=1 to 4320) included in a pixel column connected to the source bus line in which the disconnection has occurred are fixed to the clipping gray scale (256 gray scale). The reason why the 256 gray scale is used in this case is to make the description with reference to the drawing easy to understand, and the clipping gray scale on the dark side is preferably about 32 gray scale (a level of gray scale that cannot be visually recognized). In the drawing, the clipping gray scale is indicated by a dotted line, and a clipping region is hatched.

FIG. 7 illustrates an example of a case where, as illustrated at the left side of FIG. 7, the input of the pixel column connected to the source bus line in which a disconnection has occurred is configured such that a pixel at the uppermost position in the display region (Y=1) is set to 1023 gray scale, then the gray scale is gradually lowered therefrom in the downward direction of the display region, and a pixel at the lowermost position in the display region (Y=4320) is set to 0 gray scale. In this case, as illustrated at the right side of FIG. 7, as a result of the clipping processing, the output is fixed to 256 gray scale when the input is less than 256 gray scale. When the input is 256 gray scale or more, the output is equal to the input.

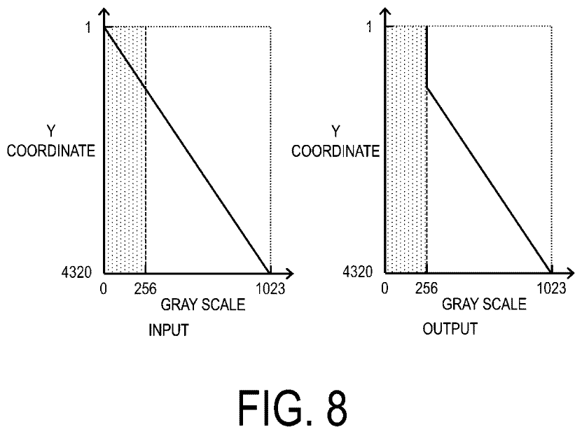

FIG. 8 illustrates an example of a case where, as illustrated at the left side of FIG. 8, the input of the pixel column connected to the source bus line in which a disconnection has occurred is configured such that a pixel at the uppermost position in the display region (Y=1) is set to 0 gray scale, then the gray scale is gradually raised therefrom in the downward direction of the display region, and a pixel at the lowermost position in the display region (Y=4320) is set to 1023 gray scale. In this case, as illustrated at the right side of FIG. 8, as a result of the clipping processing, the output is fixed to 256 gray scale when the input is less than 256 gray scale. When the input is 256 gray scale or more, the output is equal to the input.

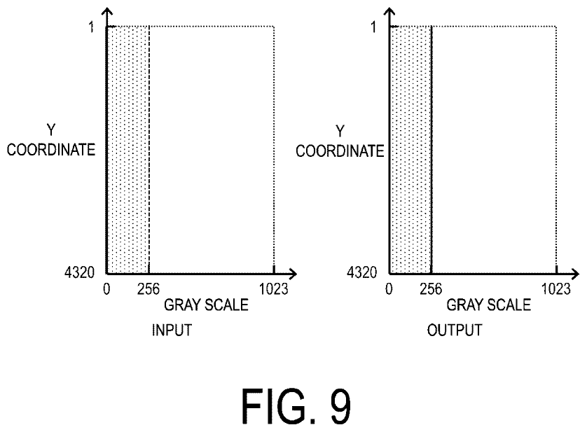

FIG. 9 illustrates an example of a case where the input of the pixel column connected to the source bus line in which a disconnection has occurred is set to 0 gray scale for all the pixels (Y=1 to 4320) included in the pixel column, as illustrated at the left side of FIG. 9. In this case, as illustrated at the right side of FIG. 9, as a result of the clipping processing, the output is fixed to 256 gray scale for all the pixels.

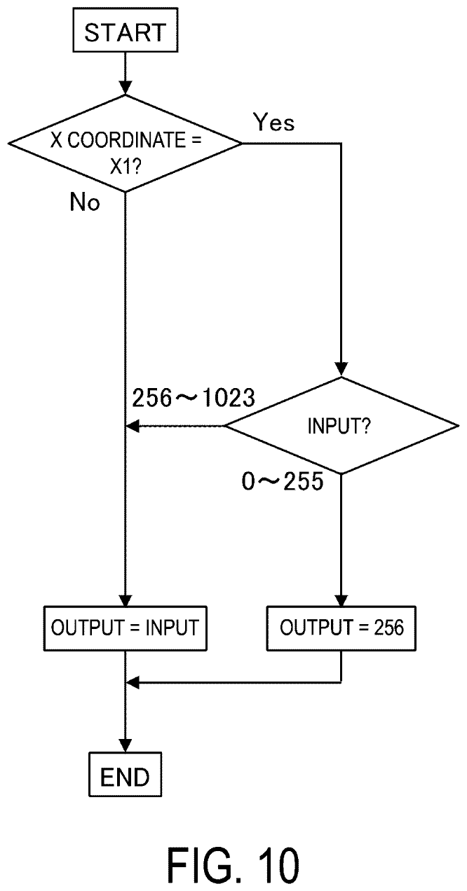

FIG. 10 illustrates a flowchart of a process (an algorithm of Example 1) performed by the correction circuit 152c (see FIG. 1) in Example 1.

As illustrated in FIG. 10, when the information of the disconnection portion (here, only the X coordinate) is stored in the ROM 153 (see FIG. 1), the information of the disconnection portion (X coordinate=X1) is read out. In a case where the X coordinate is X1, when the input gray scale is 0 gray scale or more and less than 256 gray scale (less than the clipping gray scale on the dark side), the output gray scale is fixed to 256gray scale, while when the input gray scale is from 256 gray scale to 1023 gray scale (the clipping gray scale on the dark side or more), the input gray scale is output as it is. In a case where the X coordinate is other than X1, the input gray scale is output as it is.

In Example 1, the clipping processing is performed only on the dark side (only (1) described above). Likewise, the clipping processing may be performed only on the bright side (only (2) described above), or may be performed on both the dark side and the bright side (both (1) and (2) described above).

### Example 2

Example 2 describes an example of a case where the clipping location (the position of a pixel to be subjected to clipping processing) depends on not only the X coordinate (l) specifying a source bus line in which a disconnection has occurred but also the Y coordinate (k) of the disconnection portion. In this case, the source bus line is disconnected between a portion to which a pixel (Y=3800) is connected and a portion to which a pixel (Y=3801) is connected. The pixels to be subjected to clipping processing are pixels (Y=1 to 3800) connected to the bypass side. In Example 2, setting values related to the clipping processing can be made common among different liquid crystal display devices except for the X coordinate and the Y coordinate of the disconnection portion.
Clipping location: only the bypass side of the source bus line in which the disconnection has occurred (the direct side is not clipped)
Clipping gray scale: constant independent of the Y coordinates of the pixels on the bypass side
Bright side/Dark side clipping: both the bright side and dark side (both (1) and (2) described above)

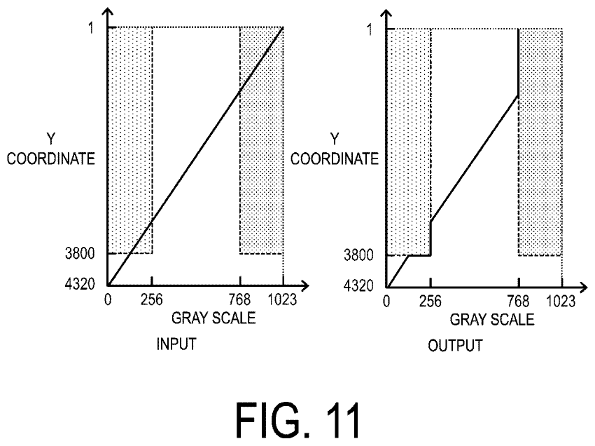

FIGS. 11 to 13 each describe a specific example of the clipping processing under the above-described conditions.

As for the pixels (Y=1 to 3800) on the bypass side of the source bus line in which the disconnection has occurred, when the original value of the gray scale (input) is less than the clipping gray scale on the dark side (the first gray scale value described above, which is 256 gray scale in this case), the gray scale is fixed to the clipping gray scale (256 gray scale), and when the original value of the gray scale (output) exceeds the clipping gray scale on the bright side (the second gray scale value described above, which is 768 gray scale in this case), the gray scale is fixed to the clipping gray scale (768 gray scale). In the drawing, the clipping gray scale is indicated by a dotted line, and the clipping region is hatched.

FIG. 11 illustrates an example of a case where, as illustrated at the left side of FIG. 11, the input of the pixel column connected to the source bus line in which a disconnection has occurred is configured such that a pixel at the uppermost position in the display region (Y=1) is set to 1023 gray scale, then the gray scale is gradually lowered therefrom in the downward direction of the display region, and a pixel at the lowermost position in the display region (Y=4320) is set to 0 gray scale. In this case, as illustrated at the right side of FIG. 11, as a result of the clipping processing for the pixels on the bypass side (Y=1 to 3800), the output is fixed to 256 gray scale when the input is less than 256 gray scale, and fixed to 768 gray scale when the input exceeds 768 gray scale. As for the pixels on the bypass side (Y=1 to 3800), when the input is in a range from 256 gray scale to 768 gray scale, the output is equal to the input. On the other hand, the clipping processing is not performed on the pixels on the direct side (Y=3801 to 4320), and the output is equal to the input regardless of the input values.

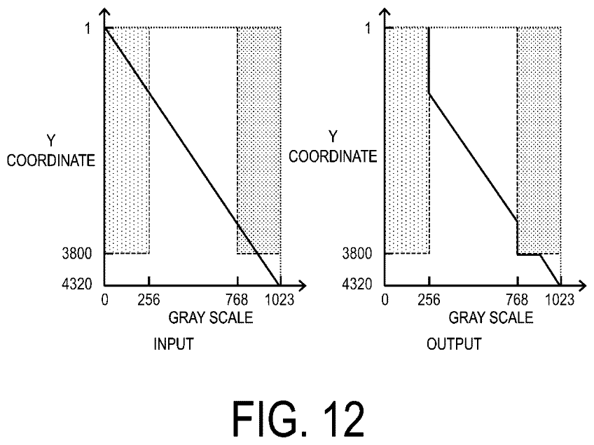

FIG. 12 illustrates an example of a case where, as illustrated at the left side of FIG. 12, the input of the pixel column connected to the source bus line in which a disconnection has occurred is configured such that a pixel at the uppermost position in the display region (Y=1) is set to 0 gray scale, then the gray scale is gradually raised therefrom in the downward direction of the display region, and a pixel at the lowermost position in the display region (Y=4320) is set to 1023 gray scale. In this case, as illustrated at the right side of FIG. 12, as a result of the clipping processing for the pixels on the bypass side (Y=1 to 3800), the output is fixed to 256 gray scale when the input is less than 256 gray scale, and fixed to 768 gray scale when the input exceeds 768 gray scale. As for the pixels on the bypass side (Y=1 to 3800), when the input is in a range from 256 gray scale to 768 gray scale, the output is equal to the input. On the other hand, the clipping processing is not performed on the pixels on the direct side (Y=3801 to 4320), and the output is equal to the input regardless of the input values.

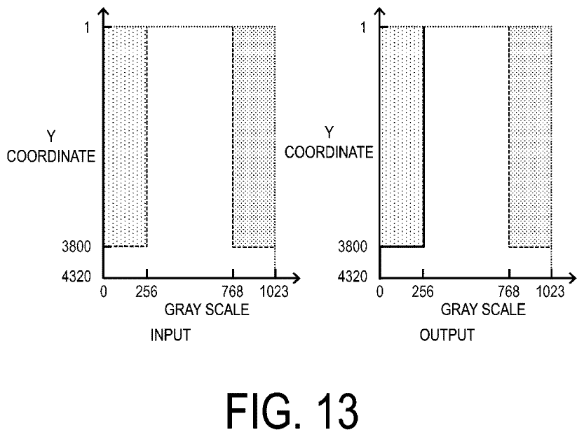

FIG. 13 illustrates an example of a case where the input of the pixel column connected to the source bus line in which a disconnection has occurred is set to 0 gray scale for all the pixels (Y=1 to 4320) included in the pixel column as illustrated at the left side of FIG. 13. In this case, as illustrated at the right side of FIG. 13, as a result of the clipping processing for the pixels on the bypass side (Y=1 to 3800), the output is fixed to 256 gray scale for all the pixels (Y=1 to 3800). On the other hand, the clipping processing is not performed on the pixels on the direct side (Y=3801 to 4320), and the output is 0 gray scale, which is equal to the input.

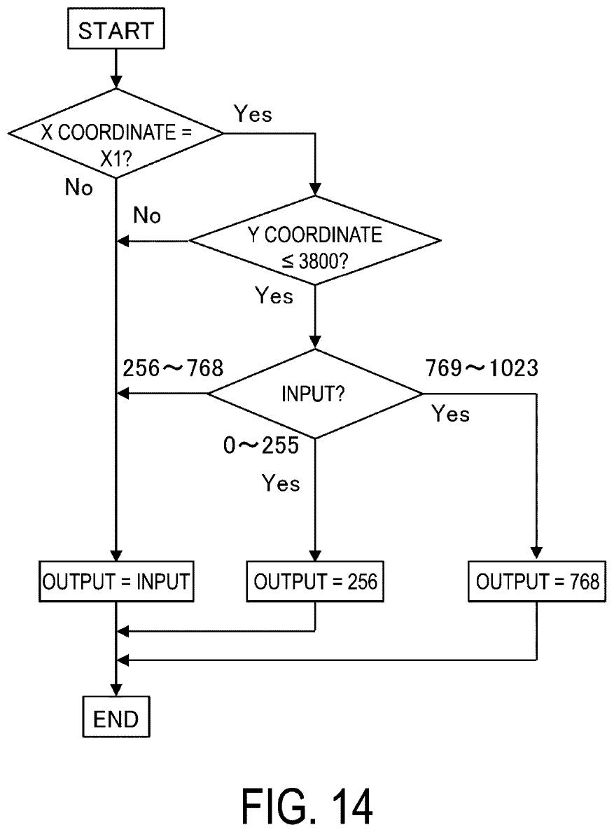

FIG. 14 illustrates a flowchart of a process (an algorithm of Example 2) performed by the correction circuit 152c (see FIG. 1) in Example 2.

As illustrated in FIG. 14, when the information of the disconnection portion is stored in the ROM 153 (see FIG. 1), the information of the disconnection portion (X coordinate=X1, Y coordinate=3800) is read out. When the X coordinate is X1,whether the Y coordinate is 3800 or less is determined. In a case where the Y coordinate is 3800 or less, when the input gray scale is 0 gray scale or more and less than 256 gray scale (less than the clipping gray scale on the dark side), the output gray scale is fixed to 256 gray scale, while when the input gray scale exceeds 768 gray scale and is equal to or less than 1023gray scale (beyond the clipping gray scale on the bright side), the output gray scale is fixed to 768 gray scale. In a case other than the above, that is, when the input gray scale is in a range from 256 gray scale to 768 gray scale (in a range from the clipping gray scale on the dark side to the clipping gray scale on the bright side), the input gray scale is output as it is. On the other hand, the clipping processing is not performed when Y is equal to or larger than 3801 (and equal to or less than 4320), and the input gray scale is output as it is. In a case where the X coordinate is other than X1, the input gray scale is output as it is.

In Example 2, the clipping processing is performed on both the dark side and the bright side (both (1) and (2) described above). However, the clipping processing may be performed only on the dark side (only (1) described above), or may be performed only on the bright side (only (2) described above). In addition, in Example 2, the clipping processing is performed only on the bypass side, but the clipping processing may also be performed on the direct side.

### Example 3

Example 3 describes an example of a case where the clipping gray scale depends on the Y coordinate. In this case, the source bus line is disconnected between a portion to which a pixel (Y=3800) is connected and a portion to which a pixel (Y=3801) is connected. The clipping processing is performed only on the dark side (only (1) described above), and the clipping gray scale on the bypass side has a different inclination from that of the clipping gray scale on the direct side.

Clipping location: all the pixels connected to the source bus line in which the disconnection has occurred are to be clipped
Common/Independent clipping: independent on the bypass side/direct side of the disconnection portion of the source bus line
Clipping gray scale: inclined depending on the Y coordinate (inclination differs between the bypass side and direct side)
Bright side/Dark side clipping: only the dark side (only (1) described above)

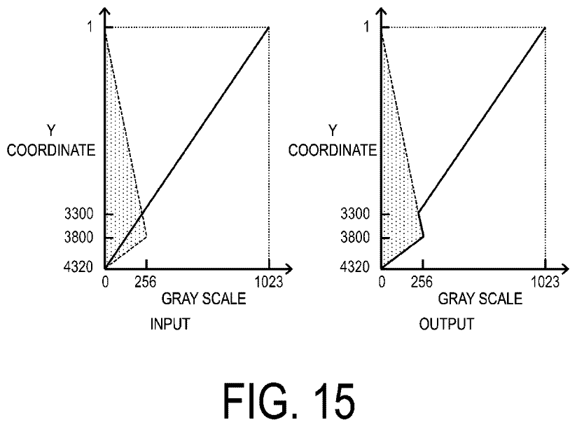

FIGS. 15 to 17 each describe a specific example of the clipping processing under the above-described conditions.

The clipping gray scale of a pixel (Y=3800) closest to the disconnection portion among the pixels on the bypass side of the source bus line in which a disconnection has occurred is set to 256 gray scale. The clipping gray scale of each of the pixels on the bypass side (Y=1 to 3800) is lowered from (Y=3800) toward (Y=1), and the clipping gray scale is set to 0 at (Y=1). The clipping gray scale of each of the pixels on the direct side of the source bus line in which the disconnection has occurred (Y=3801 to 4320) is lowered from (Y=3801) toward (Y=4320), and the clipping gray scale is set to 0 at (Y =4320). The clipping gray scale of the pixel (Y=3801) on the direct side closest to the disconnection portion (the highest value of the clipping gray scale on the direct side) is equal to or less than the clipping gray scale of the pixel (Y=3800) on the bypass side closest to the disconnection portion (the highest value of the clipping gray scale on the bypass side, which is 256 gray scale in this case). When the original value of the gray scale (input) is less than the corresponding clipping gray scale on the dark side (the clipping gray scale at the same Y coordinate as the input) for all the pixels (Y=1 to 4320) included in a pixel column connected to the source bus line in which the disconnection has occurred, the gray scale is fixed to the corresponding clipping gray scale. In the drawing, the clipping gray scale is indicated by a dotted line, and the clipping region is hatched.

The drawing illustrated at the left side of FIG. 15 is an example of a case where the input of the pixel column connected to the source bus line in which the disconnection has occurred is configured such that a pixel at the uppermost position in the display region (Y=1) is set to 1023 gray scale, then the gray scale is gradually lowered therefrom in the downward direction of the display region, and a pixel at the lowermost position in the display region (Y=4320) is set to 0 gray scale. In this case, as illustrated at the right side of FIG. 15, as a result of the clipping processing, when the input is less than the corresponding clipping gray scale, the output is fixed to the corresponding clipping gray scale. The clipping gray scale is set to be larger as the pixel is closer to the disconnection portion. That is, the clipping gray scale on the dark side (the first gray scale value in (1) described above) is set to be larger as the pixel is closer to the disconnection portion. For each pixel of (Y=3301 to 3800) among the pixels (Y=1 to 3800) on the bypass side, the input is less than the clipping gray scale of the pixel, and the output is fixed to the clipping gray scale of the pixel (the corresponding clipping gray scale on the bypass side). For each pixel of (Y=1 to 3300) among the pixels (Y=1 to 3800) on the bypass side, the input is equal to or higher than the clipping gray scale of the pixel, and the output is equal to the input. On the other hand, for each pixel of the pixels on the direct side (Y=3801 to 4320), the input is less than the clipping gray scale of the pixel, and the output is fixed to the clipping gray scale of the pixel (the corresponding clipping gray scale on the direct side).

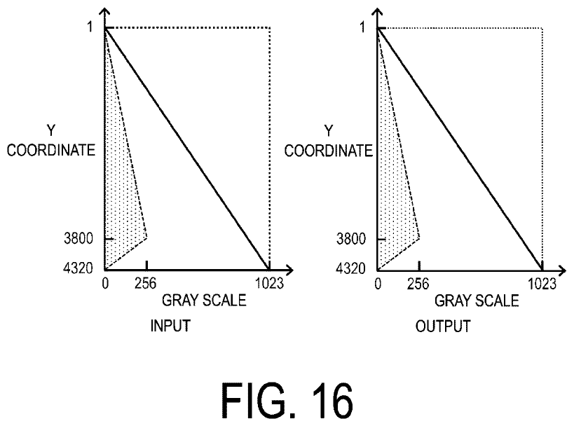

FIG. 16 illustrates an example of a case where, as illustrated at the left side of FIG. 16, the input of the pixel column connected to the source bus line in which a disconnection has occurred is configured such that a pixel at the uppermost position in the display region (Y=1) is set to 0 gray scale, then the gray scale is gradually raised therefrom in the downward direction of the display region, and a pixel at the lowermost position in the display region (Y=4320) is set to 1023 gray scale. In this case, as illustrated at the right side of FIG. 16, for all the pixels (Y=1 to 4320), the input is equal to or higher than the corresponding clipping gray scale, and the output is equal to the input.

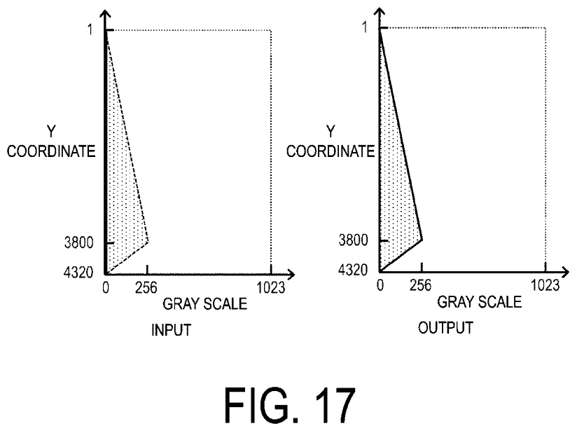

FIG. 17 illustrates an example of a case where the input of the pixel column connected to the source bus line in which a disconnection has occurred is set to 0 gray scale for all the pixels (Y=1 to 4320) included in the pixel column as illustrated at the left side of FIG. 17. In this case, as illustrated at the right side of FIG. 17, for all the pixels (Y =1 to 4320), the input is less than the corresponding clipping gray scale, and the output is fixed to the corresponding clipping gray scale. That is, the output becomes the same as the clipping gray scale for all the pixels (Y=1 to 4320).

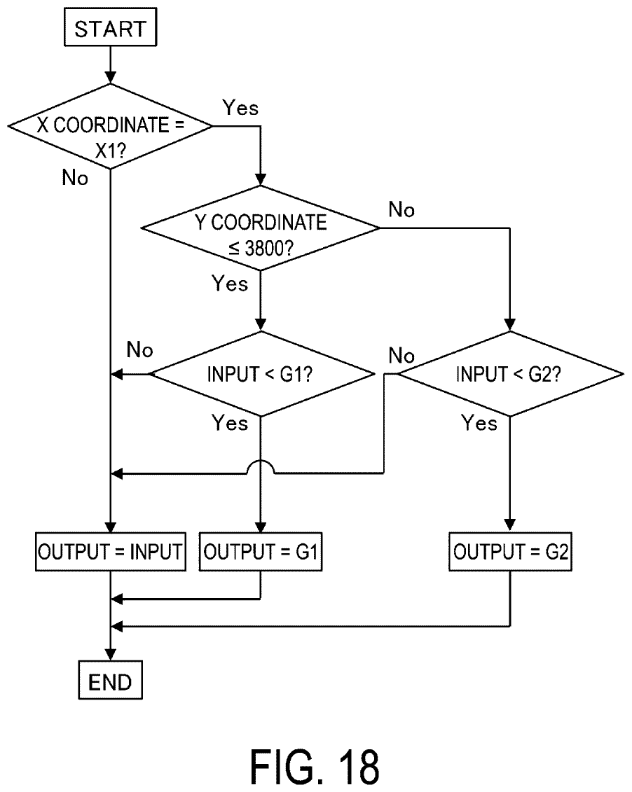

FIG. 18 illustrates a flowchart of a process (an algorithm of Example 3) performed by the correction circuit 152c (see FIG. 1) in Example 3.

As illustrated in FIG. 18, when the information of the disconnection portion is stored in the ROM 153 (see FIG. 1), the information of the disconnection portion (X coordinate=X1, Y coordinate=3800) is read out. When the X coordinate is X1, whether the Y coordinate is 3800 or less is determined. The clipping processing differs depending on whether the Y coordinate is 3800 or less. When the Y coordinate is 3800 or less and the input gray scale is smaller than a gray scale G1 (clipping gray scale on the bypass side determined in accordance with the Y coordinate) determined by a linear function, the gray scale is clipped to the gray scale G1. Here, the gray scale G1 is obtained by the calculation of G1=256×(Y coordinate−1)/3799 (the decimal is dropped). In a case other than this, the input gray scale is output as it is. When the Y coordinate exceeds 3800 and the input gray scale is smaller than a gray scale G2 (clipping gray scale on the direct side determined in accordance with the Y coordinate) determined by a linear function, the gray scale is clipped to the gray scale G2. Here, the gray scale G2 is obtained by the calculation of G2=256−256×(Y coordinate−3800)/(4320-3800) (the decimal is dropped). In a case other than this, the input gray scale is output as it is. In a case where the X coordinate is other than X1, the input gray scale is output as it is.

In Example 3, the clipping processing is performed only on the dark side (only (1) described above). Likewise, the clipping processing may be performed only on the bright side (only (2) described above), or may be performed on both the dark side and the bright side (both (1) and (2) described above). The amount of clipping on the bright side is also set to be larger as the pixel is closer to the disconnection portion. That is, the clipping gray scale on the bright side (the second gray scale value in (2) described above) is set to be smaller as the pixel is closer to the disconnection portion.

### Example 4

In Example 4, the clipping processing is performed utilizing gray scale conversion. In Example 4 as well, as in Example 1, all pixels are clipped under specified conditions regardless of the positions of the pixels connected to the source bus line in which a disconnection has occurred. Similarly to Example 1, setting values related to the clipping processing can be made common among different liquid crystal display devices except for the X coordinate (l) specifying the source bus line in which the disconnection has occurred.
Clipping location: all the pixels connected to the source bus line in which the disconnection has occurred are to be clipped
Common/Independent clipping: common to the bypass side/direct side of the disconnection portion of the source bus line
Clipping gray scale: constant conversion for all pixels without depending on the Y coordinate
Bright side/Dark side clipping: only the bright side (only (2) described above)

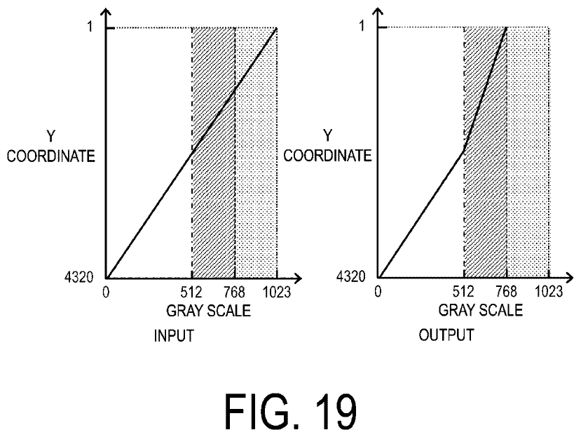

FIGS. 19 to 21 each describe a specific example of the clipping processing under the above-described conditions.

When the original value of the gray scale (input) is equal to or larger than a conversion lower limit gray scale on the bright side (the fourth gray scale value described above, which is 512 gray scale in this case) that is smaller than the clipping gray scale on the bright side (the second gray scale value described above, which is 768 gray scale in this case) for all the pixels (Y=1 to 4320) included in a pixel column connected to the source bus line in which the disconnection has occurred, the gray scale values are each converted to a conversion gray scale value (the aforementioned second conversion gray scale value) between the clipping gray scale on the bright side and the conversion lower limit gray scale. The conversion gray scale value on the bright side is set, for example, to be closer to the clipping gray scale on the bright side as a difference between the original value of the gray scale and the highest gray scale value (here, 1023 gray scale) is smaller, and to be closer to the conversion lower limit gray scale as the difference between the original value of the gray scale and the highest gray scale value is larger. This gray scale conversion may also be performed by the correction circuit 152c. In the drawing, the clipping gray scale is indicated by a dotted line, and the clipping region is hatched. Further, a region relating to accompanying correction is hatched with oblique lines.

FIG. 19 illustrates an example of a case where, as illustrated at the left side of FIG. 19, the input of the pixel column connected to the source bus line in which a disconnection has occurred is configured such that a pixel at the uppermost position in the display region (Y=1) is set to 1023 gray scale, then the gray scale is gradually lowered therefrom in the downward direction of the display region, and a pixel at the lowermost position in the display region (Y=4320) is set to 0 gray scale. In this case, as illustrated at the right side of FIG. 19, as a result of the clipping processing, when the input is equal to or larger than 512 gray scale, the input value is converted to a conversion gray scale value in a range from 512 gray scale to 768 gray scale, and the output does not exceed 768 gray scale. When the input is less than 512 gray scale, the output is equal to the input.

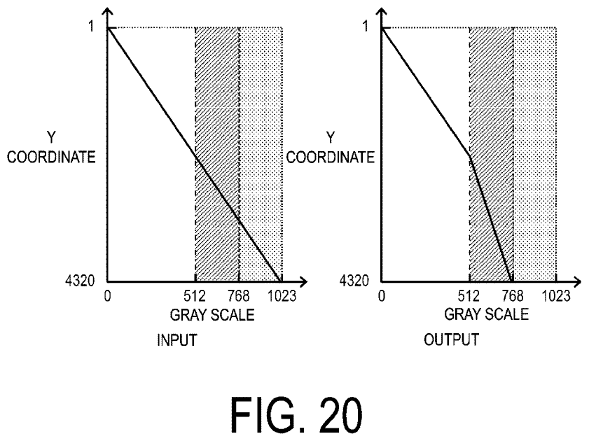

FIG. 20 illustrates an example of a case where, as illustrated at the left side of FIG. 20, the input of the pixel column connected to the source bus line in which a disconnection has occurred is configured such that a pixel at the uppermost position in the display region (Y=1) is set to 0 gray scale, then the gray scale is gradually raised therefrom in the downward direction of the display region, and a pixel at the lowermost position in the display region (Y=4320) is set to 1023 gray scale. In this case, as illustrated at the right side of FIG. 20, as a result of the clipping processing, when the input is equal to or larger than 512 gray scale, the input value is converted to a conversion gray scale value in a range from 512 gray scale to 768 gray scale, and the output does not exceed 768 gray scale. When the input is less than 512 gray scale, the output is equal to the input.

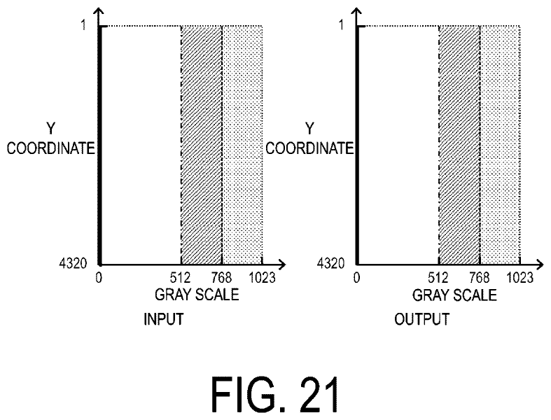

FIG. 21 illustrates an example of a case where the input of the pixel column connected to the source bus line in which a disconnection has occurred is set to 0 gray scale for all the pixels (Y=1 to 4320) included in the pixel column as illustrated at the left side of FIG. 21. In this case, as illustrated at the right side of FIG. 21, for all the pixels (Y =1 to 4320), the input is less than 512 gray scale, and the output is equal to the input.

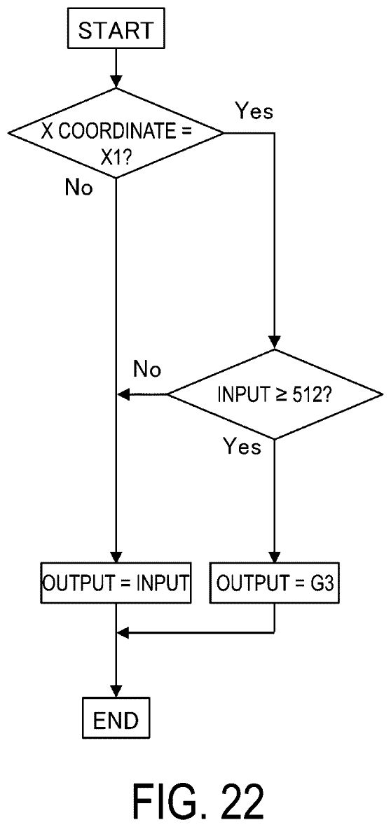

FIG. 22 illustrates a flowchart of a process (an algorithm of Example 4) performed by the correction circuit 152c (see FIG. 1) in Example 4.

As illustrated in FIG. 22, when the information of the disconnection portion (here, only the X coordinate) is stored in the ROM 153 (see FIG. 1), the information of the disconnection portion (X coordinate=X1) is read out. When the X coordinate is X1 and the input gray scale is equal to or larger than 512 gray scale (equal to or larger than the conversion lower limit gray scale on the bright side), the gray scale is clipped to a gray scale G3 (the conversion gray scale value on the bright side) determined by a linear function. Here, the gray scale G3 is obtained by the calculation of G3=768-(1023-input gray scale)×(767-511)/(1023-511) (the decimal is dropped). In a case other than this, the input gray scale is output as it is. In a case where the X coordinate is other than X1, the input gray scale is output as it is.

In Example 4, the clipping processing (gray scale conversion) is performed only on the bright side (only (2) described above). Likewise, the clipping processing may be performed only on the dark side (only (1) described above), or may be performed on both the dark side and the bright side (both (1) and (2) described above).

### INDUSTRIAL APPLICABILITY

The liquid crystal display device according to the embodiments of the disclosure is suitably used for a relatively high-resolution liquid crystal display device.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A liquid crystal display device, comprising:
a plurality of pixels arranged in a matrix shape having a plurality of pixel rows and a plurality of pixel columns;
a thin film transistor provided in each of the plurality of pixels;
a plurality of gate bus lines each associated with any of the plurality of pixel rows;
a plurality of source bus lines each associated with any of the plurality of pixel columns;
a spare wiring line arranged to be electrically connectable to any of the plurality of source bus lines;
a gate drive circuit configured to supply a gate signal to the plurality of gate bus lines;
a source drive circuit configured to supply a source signal to the plurality of source bus lines; and
a control circuit configured to supply a control signal to the gate drive circuit and the source drive circuit, wherein
the control circuit is configured to adjust a gray scale value for generating a source signal to be supplied via the spare wiring line to a source bus line electrically connected to the spare wiring line to a value not lower than a first gray scale value that is higher than a lowest gray scale value and/or to a value not higher than a second gray scale value that is lower than a highest gray scale value.

2. The liquid crystal display device according to claim 1,
wherein the control circuit is configured to adjust a gray scale value for generating a source signal to be directly supplied, not via the spare wiring line, to a source bus line electrically connected to the spare wiring line to a value not lower than the first gray scale value and/or to a value not higher than the second gray scale value.

3. The liquid crystal display device according to claim 1,
wherein the first gray scale value and/or the second gray scale value is allowed to be changed in accordance with a position of a pixel that receives a source signal to be supplied to a source bus line electrically connected to the spare wiring line.

4. The liquid crystal display device according to claim 3,
wherein as a pixel that receives a source signal to be supplied to a source bus line electrically connected to the spare wiring line is closer to a disconnection portion, the first gray scale value is made larger and/or the second gray scale value is made smaller at a time of adjusting a gray scale value for generating the source signal.

5. The liquid crystal display device according to claim 1,
wherein the control circuit is configured to adjust a gray scale value for generating a source signal to be supplied to a source bus line electrically connected to the spare wiring line either to a value not lower than the first gray scale value or to a value not higher than the second gray scale value.

6. The liquid crystal display device according to claim 1,
wherein the control circuit is configured to adjust a gray scale value for generating a source signal to be supplied to a source bus line electrically connected to the spare wiring line both to a value not lower than the first gray scale value and to a value not higher than the second gray scale value.

7. The liquid crystal display device according to claim 1,
wherein the control circuit includes a correction circuit, and
the correction circuit is configured to correct a gray scale value for generating a source signal to be supplied to a source bus line electrically connected to the spare wiring line to the first gray scale value in a case where an original value of the gray scale is lower than the first gray scale value and/or to the second gray scale value in a case where the original value of the gray scale is higher than the second gray scale value.

8. The liquid crystal display device according to claim 1,
wherein the control circuit includes a correction circuit, and
the correction circuit is configured to convert a gray scale value for generating a source signal to be supplied to a source bus line electrically connected to the spare wiring line, in a case where an original value of the gray scale is equal to or smaller than a third gray scale value that is larger than the first gray scale value, to a first conversion gray scale value between the first gray scale value and the third gray scale value and/or convert the gray scale value, in a case where the original value of the gray scale is equal to or larger than a fourth gray scale value that is smaller than the second gray scale value, to a second conversion gray scale value between the second gray scale value and the fourth gray scale value.

9. The liquid crystal display device according to claim 8,
wherein the first conversion gray scale value is allowed to be changed in accordance with a difference between the original value of the gray scale and the lowest gray scale value, and the second conversion gray scale value is allowed to be changed in accordance with a difference between the original value of the gray scale and the highest gray scale value.

10. The liquid crystal display device according to claim 9,
wherein the first conversion gray scale value is set to be closer to the first gray scale value as the difference between the original value of the gray scale and the lowest gray scale value is smaller, and closer to the third gray scale value as the difference between the original value of the gray scale and the lowest gray scale value is larger, and
the second conversion gray scale value is set to be closer to the second gray scale value as the difference between the original value of the gray scale and the highest gray scale value is smaller, and closer to the fourth gray scale value as the difference between the original value of the gray scale and the highest gray scale value is larger.
